(19) United States
(12) Patent Application Publication
(10) Pub. No.: US 2026/0293820 A1
(43) Pub. Date: Oct. 1, 2026

(54) TOOL MODULE FOR A MOBILE APPARATUS FOR MAINTAINING A LAWN

(71) Applicant: ANDREAS STIHL AG & Co. KG, Waiblingen (DE)

(72) Inventors: Johannes GUELTLINGER, Stuttgart (DE); Constantin JAEKEL, Puderbach (DE)

(73) Assignee: ANDREAS STIHL AG & Co. KG, Waiblingen (DE)

(21) Appl. No.: 19/574,625

(22) Filed: Mar. 23, 2026

(30) Foreign Application Priority Data
Mar. 26, 2025 (DE) 10 2025 111 666.0

(51) Int. Cl. A01G 20/43

(52) U.S. Cl. CPC A01G 20/43

(57) ABSTRACT

A tool module for a mobile apparatus for maintaining a lawn with a surface area and a ground area, comprising: a first tool device for processing the surface area along a working direction of the tool module; a second tool device for processing the ground area along the working direction; wherein the first tool device and the second tool device are arranged at a defined distance from each other and/or in a defined location in each case in order to transfer a material flow to the second tool device through the processing carried out by the first tool device and to partially separate the material flow by means of the second tool device in an operating state of the tool module. The invention also relates to an apparatus comprising such a tool module and a method for operating the apparatus.

### CROSS REFERENCE TO RELATED APPLICATIONS

This application claims priority under 35 U.S.C. §119 of German Application No. 10 2025 111 666.0, filed on Mar. 26, 2025, the disclosure of which is hereby incorporated by reference in its entirety.

### BACKGROUND OF THE INVENTION

The present invention relates to the field of soil cultivation machines and concerns a tool module for a mobile apparatus for maintaining a lawn. The present invention also concerns a mobile, in particular autonomously drivable and/or modularly configurable, apparatus for maintaining a lawn with a tool module, as well as a method for operating such a mobile apparatus.

Soil cultivation machines must meet different requirements depending on their area of application and intended use. For example, soil cultivation machines in the form of mobile robots are used in the care and cleaning of artificial turf. Specifically formed rollers, brushes, or spring tines are generally used as the robot's processing tools for the care and cleaning of artificial turf, for example, to align fibers or comb filler material. The tools used are individually formed for their respective purpose, that is, for the properties of the respective artificial turf, and do not allow for any adjustments, which means that the robot's configurability is limited.

The use of individually specified and therefore non-adjustable tools results in an increased traction requirement during processing. This in turn requires a more powerful drive, which means that the robot is heavier and larger in size.

For example, the use of rotating processing tools results in, depending on the state of the artificial turf to be processed, a comparatively considerable amount of filler material together with foreign material is picked up, whereby the filler material must subsequently be separated. The separating of the filler material is usually carried out by so-called vibrating screens, which require additional installation space of the robot, which in turn results in a higher weight and larger dimensions of the robot.

Various approaches to care artificial turf using robots are known from the patent literature. In this context, reference is made, for example, to the following published patents: EP 3 194 660 B1, EP 3 703 481 B1.

### SUMMARY

It is an object of the present invention is to provide a tool module for a mobile apparatus for maintaining a lawn, which is improved in particular in terms of design and configurability and is characterized by lower energy consumption. It is a further object of the present invention to provide a mobile apparatus with such a tool module, as well as a method for operating such an apparatus.

The object is solved by the features of claims 1, 10, and 11. Further embodiments and applications of the present invention are apparent from the dependent claims and are explained in more detail in the following description with partial reference to the figures.

The present invention relates, according to a first general aspect, to a tool module for a mobile apparatus for maintaining, in particular cleaning and/or caring for, a lawn with a surface area and a ground area, comprising: a first tool device for processing, in particular cleaning, the surface area essentially along a working direction of the tool module, wherein the first tool device is rotatably mounted for drive in a defined rotation direction about a first rotation axis; a second tool device for processing, in particular loosening, the ground area essentially along the working direction, wherein the second tool device is rotatably mounted for drive in the defined rotation direction about a second rotation axis; wherein the first tool device and the second tool device are arranged at a defined distance from each other and/or in a defined location in each case in order to essentially transfer a material flow to the second tool device through the processing carried out by the first tool device and to partially separate the material flow by means of the second tool device in an operating state of the tool module.

The present invention provides a tool module which, through the arrangement and configuration of the first tool device and the second tool device, enables multiple and/or different functionalities with regard to the processing of the lawn, wherein, in addition, interaction between the first tool device and the second tool device is realized in order to partially separate the material flow generated by the processing. Through the first tool device and the second tool device, several functions can for example be realized: cleaning foreign material from the blades on the surface area, raising (brushing) the blades on the surface area, combing the blades on the surface area, partially loosening and/or distributing in a essentially even manner the filler material of the ground area.

With the tool module, it is possible to free the surface area of the lawn from foreign material and, moreover, by the interaction of the first tool device and the second tool device, to substantially separate the foreign material from the material flow. The foreign material can be, for example, fallen leaves from a tree located in the immediate vicinity of the lawn to be processed.

The material flow can comprise a mixture of different materials in different forms, which are present on the surface area and/or on the ground area prior to processing.

Due to the rotatable mounting of the first tool device and the second tool device, each for drive in the defined rotation direction and thus in a common and/or identical rotation direction, a transport function with regard to the material flow can be ensured while the material flow is being processed simultaneously by the first tool device and by the second tool device. The defined rotation direction can have a rotation direction opposite to the working direction.

The first tool device can be formed as a brush roller and the second tool device can be formed as a comb roller. The first tool device and the second tool device can, in the working direction, be arranged immediately (directly) behind one another and/or next to one another. The defined distance can be a distance at which the first tool device and the second tool device overlap at least in sections and/or interlock with each other, in particular along the working direction. The defined distance can be an adjustable distance, for example by means of at least one actuator element.

The first tool device and the second tool device can be arranged interchangeably and/or replaceably on the tool module. The first tool device and the second tool device can be mounted on a module frame of the tool module in an adjustable and/or actuable manner, for example mounted so as to be displaceable linearly (translationally). The module frame can be a supporting frame (support frame) of the tool module. The defined location can comprise a defined position and/or a defined alignment relative to the surface area, the ground area, and/or the module frame.

According to a further aspect of the present invention, it can be provided that the second tool device is configured to essentially separate out an inorganic, grain-shaped, particle-shaped, and/or granular portion from the material flow and to supply the portion separated out to the ground area, to distribute it over the ground area, and/or to process it into the ground area; and/or that the second tool device is configured to transport an organic, leaf-shaped and/or elongated portion from the material flow for reception in a container element of the tool module.

The inorganic, grain-shaped, particle-shaped and/or granular portion can comprise, for example, sand grains and/or granules (in particular rubber granules). Sand grains and/or granules can each form a component of the ground area of the lawn and serve as filler material. The organic, leaf-shaped and/or elongated portion can comprise, for example, fallen leaves in the form of foliage, branches, branch components, tree fruits (for example, in the form of acorns, chestnuts, or nuts).

By means of the second tool device, a further processing of the generated material flow can accordingly take place in the sense of a separation process.

It is possible that the first tool device and/or the second tool device are each arranged to be adjustable, in particular automatically adjustable, with regard to the defined distance from each other and/or with regard to the respective defined location depending on a state of the material flow, the surface area, and/or the ground area.

The state of the material flow can be characterized by a measured mass flow and/or by a measured volume flow. The state of the surface area and/or the ground area can be characterized in each case by a contamination parameter with a foreign material.

The first tool device and/or the second tool device can, for example, be arranged, in particular mounted, in an adjustable manner by means of at least one actuator element. The at least one actuator element can, for example, be an electric, pneumatic, hydraulic, or mechanical actuating element. Depending on the state of the lawn to be processed, this can be used, for example, to realize a respective resulting and/or idealized working depth of the first tool device and/or the second tool device, thereby further increasing the effectiveness of the lawn processing.

According to a further aspect of the present invention, it can be provided that the first tool device comprises a plurality of first tool elements and the second tool device comprises a plurality of second tool elements, which are each arranged and configured to, upon driving of the first and second tool device, essentially engage with each other in sections and/or essentially strip off against each other, wherein the first tool elements and/or the second tool elements are each formed to be sectionally shape-variable, in particular spring-elastic shape-variable. The first tool elements and/or the second tool elements can each be formed to be essentially reversibly deformable.

The plurality of first tool elements and the plurality of second tool elements can be arranged and/or aligned for mutual interaction. By a sectional engaging of the plurality of first and second tool elements, a defined air flow can, for example, be formed in the operating state to support the transfer of the material flow from the first tool device to the second tool device. The flow direction of the air flow can be, at least in sections, idealized and/or resulting essentially identical to a flow direction of the material flow.

The first tool elements can be made of an essentially spring-elastic material based on a plastic. The second tool elements can be made of an essentially spring-elastic or essentially dimensionally stable material based on a metal or a metal alloy.

It is possible that the first tool device and the second tool device are each configured, in the operating state, to clean the first tool device by means of the second tool device and/or to clean the second tool device by means of the first tool device, and, in particular, to essentially remove a residual organic, leaf-shaped and/or elongated portion of the material flow from the respective tool device.

Cleaning can be realized by the formation and/or arrangement of respective tool elements of the first and second tool devices. The first tool device and the second tool device can be formed and/or arranged for mechanical cleaning of the respective other tool device, thereby ensuring the functionality of the respective tool device and reducing maintenance requirements to a minimum. In other words, the tool module can be characterized by a self-cleaning function. The residual organic, leaf-shaped, and/or elongated portion of the material flow can comprise, for example, fallen leaves in the form of foliage, branches, or branch components.

According to a further aspect of the present invention, the tool module can comprise a guide element for guiding, in particular deflecting, the material flow along a defined direction; wherein the guide element is arranged in sections in front of the first tool device in the working direction; wherein the guide element is arranged opposite to the first tool device and/or encases the first tool device in sections; wherein the guide element is arranged and/or formed to guide the material flow in the direction of the second tool element; wherein the guide element comprises a plurality of passage openings in order to essentially separate out an inorganic, grain-shaped, particle-shaped, and/or granular portion from the material flow, wherein, in particular, the plurality of passage openings form a grid-shaped or sieve-shaped section of the guide element for the passage of the portion to be separated out and/or are arranged in sections along the defined direction; and/or wherein the guide element is formed in sections in a shell-shaped and/or hood-shaped manner.

By means of the guide element, it is possible, for example, to guide the material flow essentially in sections in a circumferential direction around the first tool device. By the guide element, an air flow for supporting the transfer and/or partial separation of the material flow, which is generated by the first and/or second tool element in the operating state, can be guided in the defined direction. For example, a foreign material of the material flow in the form of dirt particles can thereby be guided in a defined direction.

By the plurality of passage openings of a grid-shaped or sieve-shaped section of the guide element and the respective arrangement of the guide element relative to the first tool device, it is possible to essentially separate out an inorganic, grain-shaped, particle-shaped and/or granular portion of the material flow, in particular in the form of sand grains and/or granulate of the filler material of the ground region, already in interaction with the first tool device.

It is possible that the tool module comprises a container element for receiving at least one portion, in particular an organic, leaf-shaped and/or elongated portion, of the material flow; wherein, in the working direction, the container element is arranged behind the first and second tool devices; wherein the container element, in particular a container bottom wall of the container element, comprises a plurality of passage openings in order to essentially separate out, from the at least one portion of the material flow received, a residual inorganic, grain-shaped, particle-shaped and/or granular portion, wherein, in particular, the plurality of passage openings form a grid-shaped or sieve-shaped section of the container element for the passage of the portion to be separated out; and/or wherein the container element is arranged to be adjustable, in particular to be automatically foldable out, at the tool module for emptying, in order to discharge the at least one portion of the material flow received from the container element.

The container element arranged behind the first tool device and behind the second tool device in the working direction serves, in particular, to receive and/or accommodate foreign material from the lawn, which has accumulated in particular on the surface area. The organic, leaf-shaped and/or elongated portion can comprise, in particular, fallen leaves, branches, and/or branch components. Sand grains and/or granules of the material flow transported into the container element can, for example, be returned to the ground area of the lawn via the plurality of passage openings, thereby realizing a further separation function of the tool module without a further additional component.

According to a further aspect of the present invention, it can be provided that the tool module comprise at least one sensor element which is configured to detect at least one of the following: a filling state and/or a weight state of a container element of the tool module for receiving at least a portion of the material flow; an operating parameter, in particular a processing depth, a drive force, and/or an imbalance of the first tool device and/or the second tool device; a state of the surface area and/or the ground area.

The at least one sensor element can be, for example, an optical sensor element, a force sensor element, a capacitive sensor element, or an ultrasonic sensor element. This allows, for example, in conjunction with an electrical/electronic control device for adjusting, in particular controlling and/or regulating, the first tool device and/or the second tool device with regard to a drive speed, the defined distance, and/or the respective location, an automated adjustment of the tool module to be realized.

It is possible that the first tool device is formed as a brush roller with a plurality of bristle elements, wherein the brush roller is configured for sweeping the surface area and/or for raising blades of the lawn within the surface area; and/or that the second tool device is formed as a tine roller with a plurality of spring tine elements, wherein the tine roller is configured to loosen the ground area, to distribute a portion separated out from the material flow over the ground area and/or for processing a portion separated out from the material flow into the ground area.

The first tool device and/or the second tool device can be formed substantially in a roller shape.

According to a second general aspect, the present invention relates to a mobile, in particular autonomously drivable and/or modularly configurable, apparatus for maintaining, in particular cleaning and/or caring for, a lawn with a surface area and a ground area, comprising: a tool module configured as disclosed herein; a drive module for generating a compressive force or a tensile force, wherein the tool module and the drive module are configured for releasable coupling with each other, and wherein the drive module is configured to set the tool module in motion in a working direction by means of the compressive force or by means of the tensile force and, in particular, to drive the first and second tool device.

The apparatus can be formed as a modularly configurable caring and/or cleaning robot for lawns, in particular for artificial turf. The apparatus can also be formed as a semi-autonomous mobile apparatus.

According to a third general aspect, the present invention relates to a method for operating a mobile apparatus for maintaining, in particular cleaning and/or caring for, a lawn with a surface area and a ground area, wherein the apparatus is configured as disclosed herein, with the method steps: a) driving the first tool device and rotating the first tool device in a defined rotation direction; b) driving the second tool device and rotating the second tool device in the defined rotation direction; c) moving the mobile apparatus over the lawn in a working direction; d) processing the surface area by the first tool device and generating a material flow by the first tool device; e) processing the ground area by the second tool device; f) transferring the material flow by the first tool device to the second tool device; g) partially separating the material flow by the second tool device.

According to a further aspect of the present invention, it can be provided that the partial separation of the material flow by the second tool device comprises: essentially separating out an inorganic, grain-shaped, particle-shaped and/or granular portion by the second tool device; supplying, in particular dropping, the portion separated out by the second tool device onto the ground area; distributing the portion separated out over the ground area; and/or processing the portion separated out into the ground area.

It is possible that the method comprises: essentially separating out an inorganic, grain-shaped, particle-shaped and/or granular portion of the material flow by the first tool device, in particular by accelerating the portion to be separated out in the direction of a guide element for guiding the material flow along a defined direction, wherein the guide element comprises a plurality of passage openings for the passage of the portion to be separated out.

To avoid repetition, features directed purely at the apparatus and/or the tool module and/or disclosed in connection therewith shall also be deemed to be disclosed as part of the method and shall be claimable, and vice versa.

### BRIEF DESCRIPTION OF THE DRAWINGS

The embodiments and features of the present invention described above can be combined with each other in any manner or as appropriate. Further or other details and advantageous effects of the present invention are explained in more detail below with reference to the accompanying figures.

It shows:

FIG. 1 a first embodiment of the tool module according to the present invention in a schematic illustration;

FIG. 2 a first embodiment of the apparatus according to the present invention in a schematic illustration.

Identical or functionally equivalent components or elements are marked with the same reference signs in the figures. For the sake of clarity, reference is also made in part to the description of other embodiments and/or figures in order to avoid repetition.

The following detailed description of the embodiments shown in the figures serves to provide further illustration or clarification and is not intended to limit the scope of the present invention in any way.

### DETAILED DESCRIPTION

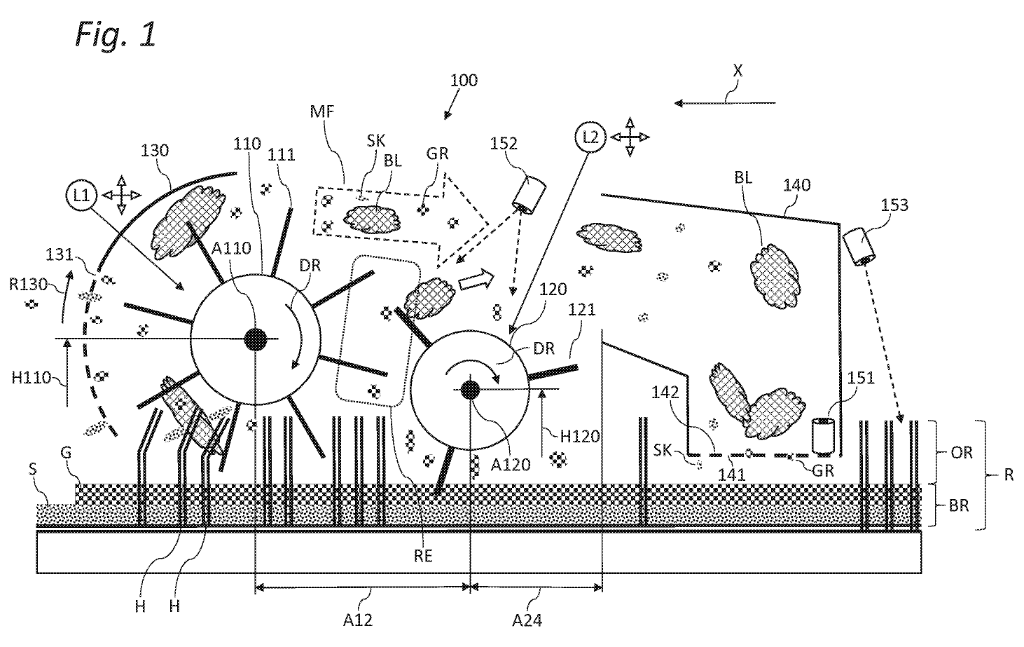

FIG. 1 shows a first embodiment of the tool module 100 according to the present invention in a schematic illustration. The tool module 100 is in an operating state. Some components of the tool module 100, such as, for example, a module frame, bearing elements, and drive elements, are omitted for reasons of clarity.

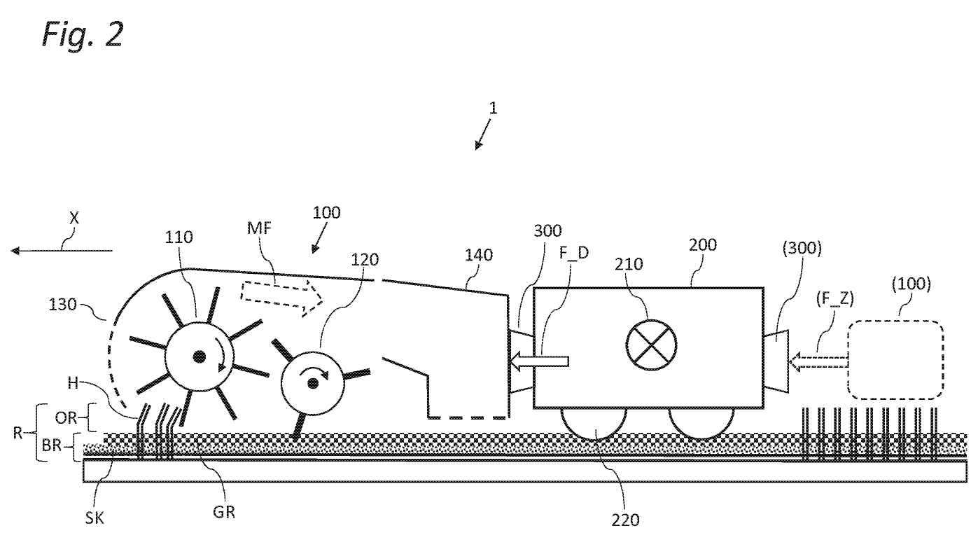

The tool module 100 is formed and/or configured for a mobile apparatus 1 for maintaining, in particular cleaning and/or caring for, a lawn R with a surface area OR and a ground area BR (see also FIG. 2). In other words, the tool module 100 is configured for mounting on the mobile apparatus 1. The tool module 100 can be a pullable tool module 100 and/or, in particular, a pushable tool module 100.

The lawn R intended for maintenance is, in particular, an artificial turf R of an outdoor area, which can be processed, in particular cleaned and/or cared for, by means of the tool module 100. The lawn R can, for example, be part of a soccer field or a golf course. As an artificial turf, the lawn R is essentially characterized by a surface area OR and a ground area BR.

The surface area OR is essentially characterized by blades H or at least sections of blades H. The blades H can be made of plastic fibers, for example based on polyethylene or polypropylene. The blades H can comprise a length that is essentially identical or different from one another.

The ground area BR comprises a filler material, which is arranged between the blades H and/or under the blades H. The filler material serves in particular to keep the blades H essentially upright, to align them and/or to essentially stabilize. The filler material of the ground area BR is essentially formed by at least two material layers S, G.

The material layer S is formed by an essentially inorganic and essentially grain-shaped material. The material layer S is in particular a layer of sand, for example based on quartz sand. The material layer G is formed by an essentially particle-shaped and/or granular material. The shape and/or size of a material particle of the material layer G is regularly essentially larger than a shape and/or size of a material particle of the material layer S. The material layer G is, in particular, a granulate layer, for example based on recycled rubber plastic.

The ground area BR can also comprise a carrier fabric (not shown in the figures for reasons of clarity) onto which the blades H are tufted for fastening. The carrier fabric can in turn rest on a defined substrate. The defined formed substrate can be, for example, concrete or asphalt. It is possible that the surface area OR and/or the ground area BR are each made of a different material or material mixture.

The tool module 100 is an autonomously mountable and thus independently manufacturable tool module 100. The tool module 100 is configured to be individually adaptable to a respective application for maintaining a lawn R. The tool module 100 is used for mechanical processing of the lawn R, in particular the surface area OR, in order to clean and/or care for the lawn R. The tool module 100 is characterized by a compact design.

The tool module 100 comprises a first tool device 110 for processing, in particular cleaning, the surface area OR of the lawn R essentially along a working direction X of the tool module 100. The working direction X is in particular a direction of movement of the tool module 100 along which the tool module 100 moves.

The first tool device 110 is rotatably mounted for drive in a defined rotation direction DR about a first rotation axis A110. The defined rotation direction DR is, in particular, a rotation direction, which has a rotation direction opposite to the working direction X. The tool module 100 comprises a second tool device 120 for processing, in particular loosening, the ground area BR essentially along the working direction X. The second tool device 120 is rotatably mounted for drive in the defined rotation direction DR about a second rotation axis A120. The rotation direction DR of the first tool device 110 and the rotation direction DR of the second tool device 120 are identical in the operating state of the tool module 100.

The first tool device 110 and the second tool device 120 are arranged at a defined distance A12 from each other and/or in a defined location L1, L2 in each case in order to essentially transfer a material flow MF to the second tool device 120 through the processing carried out by the first tool device 110 and to separate the material flow MF at least partially by means of the second tool device 120.

The material flow MF results from the state of the lawn R to be processed and is produced in particular by the tool module 100 in the operating state. The material flow MF represents material that has been set in motion and/or is in motion.

The material flow MF can comprise components or portions of the lawn R which can be returned to the lawn R. This applies in particular to the ground area BR of the lawn R. Furthermore, the material flow MF can comprise foreign material and thus foreign components or foreign portions, which must be removed from the lawn R for the maintenance of the lawn R, in particular for cleaning and care. For example, the material flow MF can comprise fallen leaves in the form of foliage, branches, branch components, tree fruits (for example, in the form of acorns, chestnuts, or nuts). In other words, the material flow MF represents a mixture of different materials in different forms set in motion as a result of the processing of the lawn R by the first and second tool devices 110, 120.

The first tool device 110 is configured to generate a material flow MF as a result of a rotational movement about the rotation axis A110 and a movement of the tool module 100 in the working direction X, and to transfer it essentially or at least partially to the second tool device 120. The first tool device 110 can additionally be configured to generate an air flow which supports the transfer of the material flow MF.

The second tool device 120 is configured to separate the material flow MF at least partially, that is, to separate a portion of the material flow MF, as a result of a rotational movement about the rotation axis A120 and a movement of the tool module 100 in the working direction X.

To realize the respective function, the first tool device 110 comprises a plurality of first tool elements 111 and the second tool device 120 comprises a plurality of second tool elements 121. The first and second tool device 110, 120 and thus the first tool elements 111 and the second tool elements 121 are each arranged relative to each other and configured to, upon driving of the first and second tool device 110, 120, engage with each other at least in sections and/or essentially strip off against each other. This ensures mutual cleaning of the first and second tool device 110, 120. In FIG. 1, the cleaning area RE between the first tool device 110 and the second tool device 120 is shown with a closed dotted line for clarification.

The first tool device 110 and the second tool device 120 are arranged relative to each other and/or configured in dependence on each other in such a way that, in the operating state, the first tool device 110 is cleaned by the second tool device 120 and/or the second tool device 120 is cleaned by the first tool device 110 and, in particular, a residual organic, leaf-shaped and/or elongated portion BL of the material flow MF is essentially removed from the respective tool device 110, 120. The organic, leaf-shaped and/or elongated portion BL can in particular comprise fallen leaves.

The first tool elements 111 and/or the second tool elements 121 are formed to be sectionally shape-variable, in particular essentially spring-elastic shape-variable and/or essentially reversibly deformable.

In the present embodiment of the tool module 100, the first tool device 110 is formed as a brush roller 110 with a plurality of bristle elements 111. The brush roller 110 is configured, among other things, for sweeping the surface area OR and/or for raising blades H of the lawn R within the surface area OR.

The second tool device 120 is formed as a tine roller 120 with a plurality of spring tine elements 121. The tine roller 120 is configured, among other things, for loosening the ground area BR, for distributing an inorganic, grain-shaped, particle-shaped and/or granular portion SK, GR separated out from the material flow MF over the ground area BR and/or for processing a portion SK, GR separated out from the material flow MF into the ground area BR.

The portion SK, GR is essentially a grain-shaped and/or granular portion SK, GR, and comprises in particular sand grains and/or rubber granules of the ground area BR of the lawn R. Due to the configuration of the second tool device 120 as a tine roller 120 and as a result of the influence of gravity, inter alia, a falling through of the separated portion SK, GR through the tine roller 120 takes place.

For guiding, in particular deflecting, the material flow MF along a defined direction R130 as a guiding direction, the tool module 100 comprises a guide element 130. The defined direction R130 is, in particular, a direction which, in a view along the rotation axis A110, extends in sections around the circumference of the first tool device 110. The defined direction R130 is a deflection direction with respect to the material flow MF.

The material flow MF is generated in particular by picking up the material BL, SK, GR lying on the lawn R and by accelerating the picked-up material BL, SK, GR by the tool elements 111 of the first tool device 110, which is further accompanied by the generation of an air flow.

The guide element 130 contributes to the formation of the air flow within the space between the guide element 130 and the first tool device 110. The guide element 130 is arranged at least in sections in front of the first tool device 110 in the working direction X. An outer side of the tool module 100, in particular in the working direction X, is defined by the guide element 130.

The guide element 130 is formed flat, curved, and essentially plate-shaped. The guide element 130 can be formed as a single piece or multiple pieces. The guide element 130 can be formed as a comparatively thin guide plate. The guide element 130 can be formed to be hood-shaped in sections or shell-shaped in sections. The guide element 130 can be formed of an essentially dimensionally stable and/or resistant plastic or based on a metal or metal alloy.

As can be seen from the illustration in FIG. 1, the guide element 130 is arranged opposite the first tool device 110 and encases the first tool device 110 in sections. The formation of the guide element 130 and its arrangement relative to the first tool device 110 results in an air flow essentially along the defined direction R130 in the operating state of the first tool device 110 together with the material flow MF, which supports the transport of the material flow MF or at least the portion BL.

As a result of the rotational movement of the first tool element 110 in the rotation direction DR, the material BL, SK, GR picked up by the first tool element 110 is subjected to centrifugal force, among other things. The guide element 130 comprises a plurality of passage openings 131, which are arranged and/or formed along the defined direction R130 as the guiding direction and thus in the direction toward the second tool element 120. The plurality of passage openings 131 can, for example, form a grid-shaped or sieve-shaped section of the guide element 130. A respective arrangement, shape, and/or size of the plurality of passage openings 131 can be formed depending on the portions SK, GR of the material flow MF. The grid-shaped or sieve-shaped section of the guide element 130 with the plurality of passage openings 131 can be configured to be replaceable and/or interchangeable. In other words, the section of the guide element 130 with the plurality of passage openings 131 can be formed as an interchangeable screen or interchangeable grid, whereby the tool module 100 is characterized by improved configurability.

The passage openings 131 are, in particular, arranged, formed, and dimensioned in such a way to separate out the portion SK, GR from the material flow MF along the defined direction R130 by passing through the passage openings 131. The passage openings 131 of the guide element 130 serve in particular for the passage of sand grains and rubber granulate of the ground area BR of the lawn R. This eliminates the need for an additional component in the form of a vibrating screen in the tool module 100, for example.

The tool module 100 comprises a container element 140. The container element 140 serves essentially for receiving and storing the organic, leaf-shaped and/or elongated portion BL of the material flow MF. In other words, the container element 140 serves to receive and accommodate fallen leaves in the form of foliage, branches, branch components, tree fruits (for example, in the form of acorns, chestnuts, or nuts). The container element 140 forms, in particular, a leaf container.

The container element 140 is arranged behind the first tool device 110 and behind the second tool device 120 in a view in the direction of the working direction X. The container element 140 is arranged in sections opposite the guide element 130 in the working direction X and forms a further outer side of the tool module 100, in particular in the working direction X. The distance A24 between the second tool device 120 and the container element 140 can be an adjustable distance, for example by means of at least one actuator element.

The container element 140 comprises a container bottom wall 142, on which passage openings 141 are formed. The passage openings 141 are in particular arranged, formed and dimensioned in such a way that they essentially separate out a residual inorganic, grain-shaped, particle-shaped and/or granular portion SK, GR from the collected portion SK, GR, BL of the material flow MF. The plurality of passage openings 141 can form a grid-shaped or sieve-shaped section of the container element 140, that is, of the container bottom wall 142, in order to realize a passage of the portion SK, GR to be separated out.

The container element 140 can be arranged on the tool module 100, in particular on a module frame of the tool module 100, so as to be adjustable, in particular automatically foldable out, for emptying, in order in particular to discharge the received portion BL of the material flow MF from the container element 140.

The tool module 100 can be individually adapted to different conditions and configurations of the lawn R. The first tool device 110 and/or the second tool device 120 are arranged to adjustable, in particular automatically adjustable, with regard to the defined distance A12 from each other along the working direction X, and/or with regard to the respective defined location L1, L2 depending on the state of the material flow MF, the surface area OR, and/or the ground area BR.

For example, for automated adjustment of the defined distance A12 and/or the respective defined locations L1, L2, the tool module 100 can comprise, among other things, at least one sensor element 151, 152, 153. The at least one sensor element 151, 152, 153 can be configured to detect at least one of the following: a filling state and/or a weight state of the container element 140; a processing depth H110, H120 of the first and/or second tool device 110, 120 relative to the surface area OR and/or to the ground area BR; a drive force, and/or an imbalance of the first tool device 110 and/or the second tool device 120; a state of the surface area OR and/or the ground area BR.

By means of the first tool device 110, a cleaning of the surface area OR and furthermore a raising and/or aligning of the blades H can be realized. By means of the second tool device 120, a loosening of the filler material S, G of the ground region BR can be realized. Moreover, by the arrangement of the first and second tool device 110, 120 relative to each other in defined locations L1, L2 and by a rotational movement in a defined, identical rotation direction DR, a mutual cleaning of the tool devices 110, 120 can be realized, whereby the tool module 100 is characterized according to the present invention.

As already described, the tool devices 110, 120 can be mounted on a module frame of the tool module 100 in an adjustable manner. The tool devices 110, 120 can be mounted independently of each other in an adjustable manner, for example in respective associated guide rails of the module frame for linear (translational) displacement mounting. Each tool device 110, 120 can be coupled for adjustment with at least one actuator element, which is supported, for example, on the module frame. The at least one actuator element can be, for example, an electric, pneumatic, hydraulic, or mechanical actuating element.

FIG. 2 shows a first embodiment of the apparatus 1 according to the present invention in a schematic representation.

The apparatus 1 is an at least partially autonomous mobile or, in particular, autonomous mobile apparatus 1 for maintaining, in particular cleaning and/or caring for, the lawn R. The apparatus 1 is an individually and/or modularly configurable apparatus 1. The apparatus 1 is formed in particular as a mobile artificial turf care robot.

The apparatus 1 comprises the tool module 100 from FIG. 1. The apparatus 1 further comprises a drive module 200 with a drive unit 210 and a chassis 220. The drive module 200 serves to generate a compressive force F_D on the tool module 100 along the working direction X, as well as to drive the first and second tool devices 110, 120. For this purpose, the drive module 200 is configured via the interface device 300 of the apparatus 1 for mounting and thus for mechanical and/or electrical coupling of the tool module 100.

Alternatively, the drive module 200 can be configured to generate and transmit a tensile force F_Z to the tool module 100 in order to pull the tool module 100 along the working direction X during operation in a corresponding design of the tool module 100. The drive module 200 can be configured by means of the interface device 300 for coupling further and/or other tool modules in order to represent an individual configurability of the apparatus 1.

The present invention is not limited to the embodiments described above. Rather, a variety of variants and modifications are possible which also make use of the inventive concept and therefore fall within the scope of protection. In particular, the present invention also claims protection for the subject matter and features of the dependent claims independently of the claims referred to.

### REFERENCE LIST

1 apparatus

100 tool module

110 tool device

111 tool element

120 tool device

121 tool element

130 guide element

131 passage opening

140 container element

141 passage opening

142 container bottom wall

151 sensor element

152 sensor element

153 sensor element

200 drive module

210 drive unit

220 chassis

300 interface device

A12 distance

A24 distance

A110 rotation axis

A120 rotation axis

BL portion of material flow

BR ground area

DR rotation direction

F_D compressive force

F_Z tensile force

G material layer

GR portion of material flow

H blade

H110 processing depth

H120 processing depth

L1 location

L2 location

MF material flow

OR surface area

R lawn

RE cleaning area

R130 guiding direction

S material layer

SK portion of material flow

X working direction

What is claimed is:

1. A tool module for a mobile apparatus for maintaining a lawn with a surface area and a ground area, comprising:
a first tool device for processing the surface area along a working direction of the tool module, wherein the first tool device is rotatably mounted for drive in a defined rotation direction about a first rotation axis;
a second tool device for processing the ground area along the working direction, wherein the second tool device is rotatably mounted for drive in the defined rotation direction about a second rotation axis;
wherein the first tool device and the second tool device are arranged at a defined distance from each other and/or in a defined location in each case in order to transfer a material flow to the second tool device through the processing carried out by the first tool device and to partially separate the material flow by means of the second tool device in an operating state of the tool module.

2. The tool module according to claim 1,
wherein the second tool device is configured to separate out an inorganic, grain-shaped, particle-shaped and/or granular portion from the material flow and to supply the portion separated out to the ground area, to distribute it over the ground area and/or to process it into the ground area; and/or
wherein the second tool device is configured to transport an organic, leaf-shaped and/or elongated portion from the material flow for reception in a container element of the tool module.

3. The tool module according to claim 1,
wherein the first tool device and/or the second tool device are each arranged to be adjustable with respect to the defined distance from each other and/or the respectively defined location depending on a state of the material flow, the surface area and/or the ground area.

4. The tool module according to claim 1,
wherein the first tool device comprises a plurality of first tool elements and the second tool device comprises a plurality of second tool elements, which are each arranged and configured to, upon driving of the first and second tool device, engage with each other in sections and/or to strip off against each other,
wherein the first tool elements and/or the second tool elements are each formed to be sectionally shape-variable.

5. The tool module according to claim 1,
wherein the first tool device and the second tool device are each configured, in the operating state, to clean the first tool device by means of the second tool device and/or to clean the second tool device by means of the first tool device.

6. The tool module according to claim 1,
wherein the tool module comprises a guide element for guiding the material flow along a defined direction;
wherein the guide element is arranged in sections in front of the first tool device in the working direction;
wherein the guide element is arranged opposite to the first tool device and/or encases the first tool device in sections; wherein the guide element is arranged and/or formed to guide the material flow in the direction to the second tool element;
wherein the guide element comprises a plurality of passage openings to separate out an inorganic, grain-shaped, particle-shaped and/or granular portion from the material flow; and/or
wherein the guide element is formed in sections in a shell-shaped and/or hood-shaped manner.

7. The tool module according to claim 6,
wherein the plurality of passage openings form a grid-shaped or sieve-shaped section of the guide element for the passage of the portion to be separated out or are arranged in sections along the defined direction.

8. The tool module according to claim 1,
wherein the tool module comprises a container element for receiving at least one portion of the material flow;
wherein, in the working direction, the container element is arranged behind the first and second tool devices;
wherein the container element comprises a plurality of passage openings to separate out, from the at least one portion of the material flow received, a residual inorganic, grain-shaped, particle-shaped and/or granular portion; and/or
wherein the container element is arranged to be adjustable at the tool module for emptying, in order to discharge the at least one portion of the material flow received from the container element.

9. The tool module according to claim 8,
wherein the plurality of passage openings form a grid-shaped or sieve-shaped section of the container element for the passage of the portion to be separated out.

10. The tool module according to claim 1,
wherein the tool module comprises at least one sensor element which is configured to detect at least one of the following:
a filling state and/or a weight state of a container element of the tool module for receiving at least a portion of the material flow;
an operating parameter, a drive force, and/or an imbalance of the first tool device and/or the second tool device;
a state of the surface area and/or the ground area.

11. The tool module according to claim 1,
wherein the first tool device is formed as a brush roller with a plurality of bristle elements, wherein the brush roller is configured for sweeping the surface area and/or for raising blades of the lawn within the surface area; and/or
wherein the second tool device is formed as a tine roller with a plurality of spring tine elements, wherein the tine roller is configured to loosen the ground area, to distribute a portion separated out from the material flow over the ground area and/or for processing a portion separated out from the material flow into the ground area.

12. A mobile apparatus for maintaining a lawn with a surface area and a ground area, comprising:
a tool module configured according to claim 1;
a drive module for generating a compressive force or a tensile force,
wherein the tool module and the drive module are configured for releasable coupling with each other, and
wherein the drive module is configured to set the tool module in motion in a working direction by means of the compressive force or by means of the tensile force.

13. A method for operating a mobile apparatus for maintaining a lawn with a surface area and a ground area, wherein the apparatus is configured according to claim 12, with the method steps:
a) driving the first tool device and rotating the first tool device in a defined rotation direction;
b) driving the second tool device and rotating the second tool device in the defined rotation direction;
c) moving the mobile apparatus over the lawn in a working direction;
d) processing the surface area by the first tool device and generating a material flow by the first tool device;
e) processing the ground area by the second tool device;
f) transferring the material flow by the first tool device to the second tool device;
g) partially separating the material flow by the second tool device.

14. The method according to claim 13,
wherein the partial separation of the material flow by the second tool device comprises:
separating out an inorganic, grain-shaped, particle-shaped and/or granular portion by the second tool device;
supplying the portion separated out by the second tool device onto the ground area;
distributing the portion separated out over the ground area; and/or
processing the portion separated out into the ground area.

15. The method according to claim 13, further comprising the step of:
separating out an inorganic, grain-shaped, particle-shaped and/or granular portion of the material flow by the first tool device,
wherein the guide element comprises a plurality of passage openings for the passage of the portion to be separated out.
